(19) United States
(12) Patent Application Publication
(10) Pub. No.: US 2009/0244761 A1
(43) Pub. Date: Oct. 1, 2009

(54) MEMORY DEVICE

(75) Inventor: Yoshinori Inoue, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/372,442

(22) Filed: Feb. 17, 2009

(30) Foreign Application Priority Data
Mar. 28, 2008 (JP) 2008-087082

(51) Int. Cl. G11B 5/02

(52) U.S. Cl. 360/55

(57) ABSTRACT

A method of controlling a memory device connectable to an information apparatus for sending out a command to the memory device, the memory device having a medium for storing data and a head for writing data into and reading data from the medium, the method includes storing parameter information for writing data into and reading out the data from the medium into the medium when formatting the medium, writing into the medium history information indicating user data has been written into the medium in accordance with the parameter information, and determining whether to allow the parameter information to be changed when a command for writing new parameter information is received from the information apparatus in accordance with the history information.

### CROSS-REFERENCE TO RELATED APPLICATION

This application is based upon and claims the benefit of priority of the prior Japanese Patent Application No. 2008-087082, filed on Mar. 28, 2008, the entire contents of which are incorporated herein by reference.

### FIELD

A certain aspect of the embodiments discussed herein is related to a memory device.

### BACKGROUND

A memory device, for example, a hard disk drive (HDD) is used as an auxiliary storing device of a computer, and stores and reads out data in response to a command transmitted from the computer. For example, the hard disk drive (HDD) includes a magnetic disk as a recording medium, and receives a writing command transmitted together with data from an external computer and then writes the data into the magnetic disk. Further, the HDD receives a reading command, then reads out the data from the magnetic disk, and outputs the data read out from the magnetic disk to the computer.

The magnetic disk in the HDD stores various information including setting parameters, for example, a setting parameter of the HDD, as various information necessary for writing and reading the data in addition to the data transmitted from the computer. The setting parameter is stored in a manufacturing step, for example, before product shipment of the HDD, to an area different from the data of the computer. Further, an operation for externally writing the setting parameter from the HDD and externally reading the parameter to the HDD is executed in accordance with a dedicated command different from a data command for writing and reading the data.

All operations necessary for writing and reading the data by the computer are assigned to data commands. After manufacturing the HDD, a command dedicated for the setting parameter does not need to be executed. Further, the operation for externally writing and reading the setting parameter from the HDD after manufacturing the HDD is not preferable in terms of the operational stability and information security. Therefore, the limiting of writing and reading the setting parameter is demanded.

Under the situation, it is well-known that an information processing device comprises a detachable data-storing unit that stores data and a data management unit. The number of readable times to the data storing unit in the data management unit is changed after the operation for writing the data to the data storing unit, and the access to the data storing unit is limited depending on the number of readable times (refer to Japanese Laid-open Patent Publication No. 2006-350494).

### SUMMARY

According to an aspect of an embodiment, a method of controlling a memory device connectable to an information apparatus for sending out a command to the memory device, the memory device having a medium for storing data and a head for writing data into and reading data from the medium, the method includes storing parameter information for writing data into and reading out the data from the medium into the medium when formatting the medium, writing into the medium history information indicating user data has been written into the medium in accordance with the parameter information, and determining whether to allow the parameter information to be changed when a command for writing new parameter information is received from the information apparatus in accordance with the history information.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram showing an HDD as an information storing device according to the first embodiment;

FIG. 2 is a block diagram showing an internal structure of the HDD shown in FIG. 1;

FIG. 3 is a diagram showing a magnetic disk of the HDD shown in FIG. 2;

FIGS. 4A and 4B are diagrams for explaining an arrangement example of sectors on a track on the magnetic disk shown in FIG. 3;

FIG. 5 is a diagram showing a sector pulse positional-information table;

FIG. 6 is a block diagram showing a structure of a formatting control unit shown in FIG. 2;

FIGS. 7A and 7B are timing charts for explaining a relationship between data and a sector pulse read from the magnetic disk;

FIG. 8 is a diagram showing a data structure of the sector stored to the magnetic disk shown in FIG. 3;

FIG. 9 is a flowchart for explaining physical formatting processing of the HDD shown in FIG. 2;

FIG. 10 is a flowchart for explaining user command processing of the HDD shown in FIG. 2;

FIG. 11 is a flowchart for explaining vendor command processing of the HDD shown in FIG. 2;

FIG. 12 is a flowchart for explaining system recording processing of the HDD shown in FIG. 2;

FIG. 13 is a flowchart for explaining power-on processing of the HDD shown in FIG. 2;

FIG. 14 is a diagram showing sector pulse positional-information table in an HDD according to the second embodiment;

FIG. 15 is a flowchart for explaining physical formatting processing of the HDD according to the second embodiment;

FIG. 16 is a flowchart for explaining user command processing of the HDD according to the second embodiment; and

FIG. 17 is a flowchart for explaining vendor command processing of the HDD according to the second embodiment.

### DESCRIPTION OF EMBODIMENTS

Hereinbelow, a description will be given of the basic structures and the applying structures thereof of the information storing device according to embodiments with reference to the drawings.

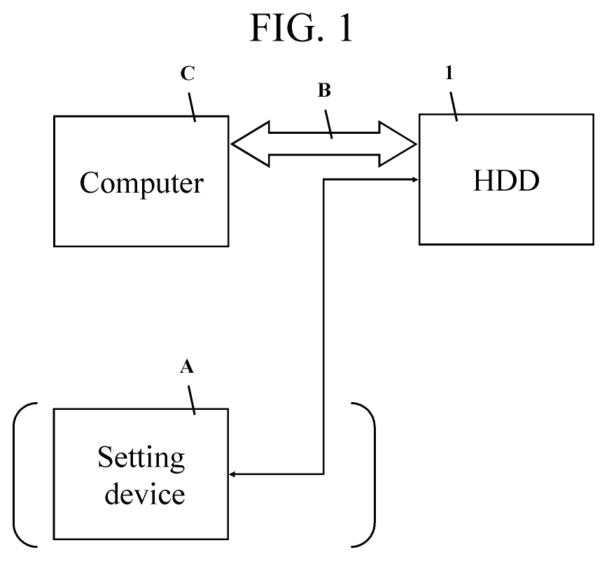

FIG. 1 is a block diagram showing an HDD as an information storing device according to the first embodiment. In FIG. 1, the HDD is shown together with a computer.

An HDD 100 shown in FIG. 1 is connected to a computer C, typically, e.g., a personal computer via a cable B, and is used as an auxiliary storing device of the computer C. The HDD 100 stores and reads data in response to a command sent from the computer C. When the HDD 100 is in a manufacturing step before shipment to a factory, a setting device A in place of the computer C is connected to the HDD 100. The setting device A is one of the computers, and transmits a command to the HDD 100, and examines the HDD 100 and sets a parameter.

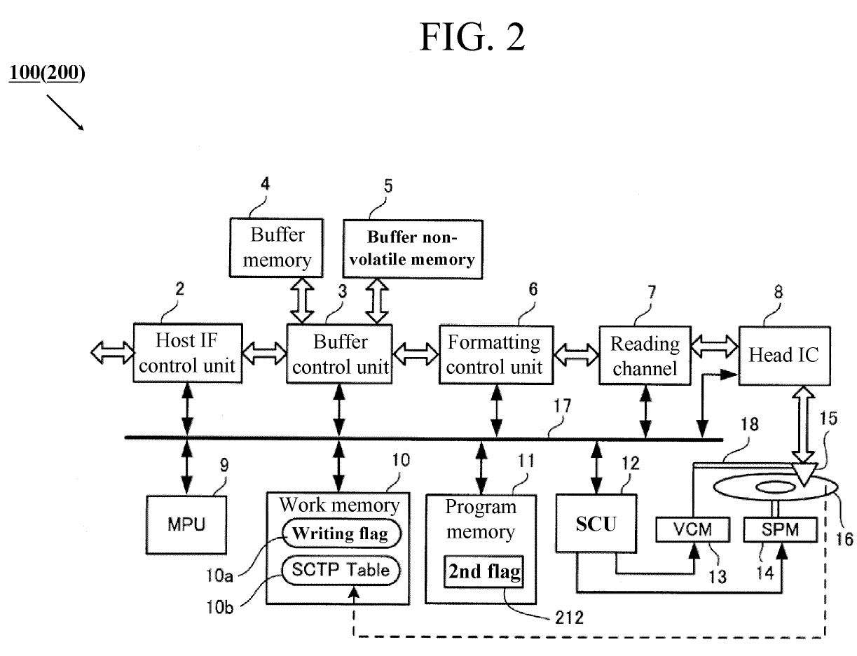

FIG. 2 is a block diagram showing the internal structure of the HDD shown in FIG. 1.

The HDD 100 shown in FIG. 2 comprises: a host interface (IF) control unit 2; a buffer control unit 3; a buffer memory 4; a buffer non-volatile memory 5; a formatting control unit 6; a reading channel 7; a head IC 8; a micro processing unit (MPU) 9; a work memory 10; a program memory 11; a servo control unit 12; a voice coil motor (VCM) 13; a spindle motor (SPM) 14; a magnetic head 15; and a magnetic disk 16. The host IF control unit 2, buffer control unit 3, formatting control unit 6, reading channel 7, micro processing unit (MPU) 9, work memory 10, program memory 11, and servo control unit 12 are mutually connected thereto via an internal bus 17. Further, the host IF control unit 2, buffer control unit 3, formatting control unit 6, reading channel 7, reading channel 7, head IC 8, and magnetic head 15 are serially connected thereto, and data is received and transmitted in order thereof or inverse one. The buffer memory 4 and buffer non-volatile memory 5 are connected to the buffer control unit 3, and the VCM 13 and SPM 14 are connected to the servo control unit 12.

The host IF control unit 2 is connected to the computer C or setting device A, receives a command and data from the computer C or setting device A, and transmits the data read from the magnetic disk 16 to the computer C or setting device A. The command received by the host IF control unit 2 is transmitted to the MPU 9. Further, the host IF control unit 2 transmits status information indicating an execution result of the command to the computer C or setting device A. When the HDD 100 prohibits the reception of a command transmitted from the computer C or the setting device A, the status information indicating an error is transmitted.

The command transmitted from the computer C or setting device A includes a user command of a user command system and a vendor command of a vendor command system.

The user command system uses the HDD 100 as the auxiliary storing device of the computer C. The user command system includes, e.g., a data writing command for storing the data to the HDD 100 and a data reading command for reading the data stored in the HDD 100 from the HDD 100. As the user command system, e.g., ATA (AT attachment) command system is used.

The vendor command system is used for setting the HDD 100 by the setting device A upon manufacturing the HDD 100, and includes a parameter writing command for enabling an operating parameter of the HDD 100 to be stored to the HDD 100, a parameter reading command for reading a parameter from the HDD 100, and a physical formatting command for performing the physical formatting of the magnetic disk 16 in the HDD 100.

Herein, the user command system corresponds to an example of the first command system in the basic structure, and the vendor command system corresponds to an example of the second command system in the basic structure. Further, the data writing command and the data reading command individually correspond to examples of the first command in the basic structure, and the parameter writing command and the parameter reading command individually correspond to examples of the second command in the basic structure.

The buffer control unit 3 performs temporary storage by storing the data read from the magnetic disk 16 to the buffer memory 4 or the buffer non-volatile memory 5 in accordance with the data transmitted together with the data writing command from the computer C and the data reading command from the computer C. The buffer memory 4 is a RAM, and the buffer non-volatile memory 5 is a flash memory that can store the data that is stored even in a power-off state.

The formatting control unit 6 performs processing of the data in a format stored in the magnetic disk 16. The magnetic disk 16 stores the data on the unit basis of sector. The formatting control unit 6 extracts the data in a target sector from a column of the data outputted from the magnetic head 15 at the reading time, and outputs the data to the magnetic head 15 at the timing corresponding to the target sector at the writing time. Details of the formatting control unit 6 and the sector format will be described later.

The reading channel 7 modulates/demodulates code in accordance with a storage system of the magnetic disk 16. The head IC 8 amplifies a signal outputted from the magnetic head 15, and also amplifies a signal to be supplied to the magnetic head 15. The magnetic head 15 applies, to the magnetic disk 16, a magnetic field corresponding to the signal transmitted from the reading channel 7 via the head IC 8 at the writing time of the data. Further, the magnetic head 15 generates an electrical signal corresponding to the magnetic field from the magnetic disk 16 at the reading time of the data and transmits the generated signal to the reading channel 7 via the head IC 8.

The SPM 14 rotates the magnetic disk 16. Further, the VCM 13 rotates an arm 18, thereby moving the magnetic head 15 in the radius direction of the magnetic disk 16. The servo control unit 12 keeps the rotating speed of the SPM 14, and controls the VCM 13, thereby positioning the magnetic head 15 on the target of the magnetic disk 16.

The MPU 9 has a function for executing various programs and controls the units in the HDD 100.

The program memory 11 stores various programs for realizing processing of the HDD 100 by the execution of the MPU 9 and constants necessary for executing various programs. The MPU 9 enables the program stored in the program memory 11 at the power-on time to be stored in the work memory 10, and executes the program stored in the work memory 10 while using the work memory 10 as a work area. The work memory 10 stores a writing flag 10a, a sector pulse (SCTP) table 10b, and a parameter used for reading the data to the user area for reading and writing on the magnetic disk 16, which will be described later. The executed processing will be described later.

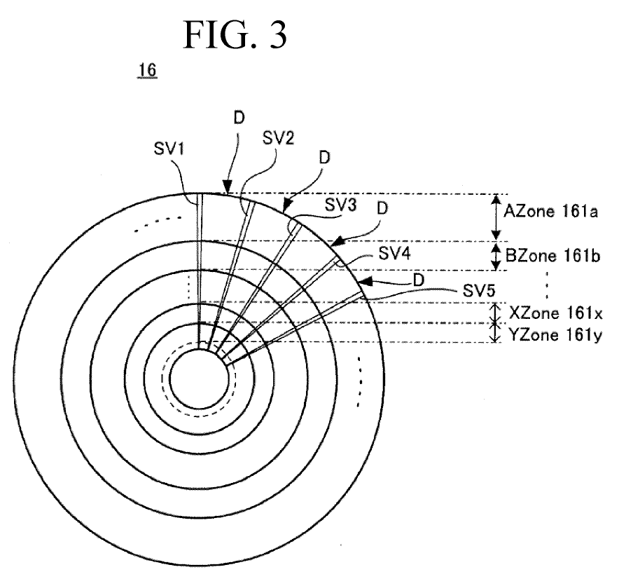

FIG. 3 is a diagram showing the magnetic disk in the HDD shown in FIG. 2.

A large number of tracks (not shown) are concentrically provided on the magnetic disk 16, magnetization is along the tracks, and information is expressed by the direction of magnetization. Further, the magnetic disk 16 stores servo information for positioning the magnetic head 15 to the magnetic disk 16 on areas SV1, SV2, SV3, SV4, SV5, . . . extended radially from the center. The areas SV1, SV2, SV3, SV4, SV5, . . . for storing the servo information are referred to as servo areas. Along the tracks, an area D for storing the data and the servo areas SV1, SV2, . . . are alternately arranged. Upon storing and reading the data to the magnetic disk 16, the servo control unit 12 controls the VCM 13 to drive the arm 18 on the basis of the servo information read from the servo areas SV1, SV2, . . . , thereby positioning the magnetic head 15 on a target track on the magnetic disk 16. The movement of the magnetic head 15 between the tracks is refereed to as seeking. The positioned magnetic head 15 is relatively moved along the tracks on the magnetic disk 16 by rotating the magnetic disk 16. Upon storing the data, an electrical recording signal is inputted to the magnetic head 15. The magnetic head 15 applies a magnetic field in accordance with the inputted recording signal and thus records the information. Further, upon reading the data, the magnetic head 15 extracts the information recorded in the magnetization direction by generating an electrical reproducing signal in accordance with the magnetic field generated by the magnetization.

The magnetic disk 16 includes a user area for storing the data written and read by the user command, a system area for storing an operation history for maintenance of the data used for the operation of the HDD 100, and a parameter area for storing a parameter used for reading the data to the user area for reading and writing on the magnetic disk 16 by the user command. The parameter area stores the data stored to the user area or the parameter for converting the parameter read from the user area, and a sector pulse (SCTP) table, which will be described later, as parameters. The parameter in the parameter area is stored or read from an external device of the HDD 100, such as the setting device A, by using the vendor command.

A region of the magnetic disk 16 is used by dividing a plurality of zones having an A zone 161a, a B zone 161b, . . . , and an X zone 161x and a Y zone 161y in the radial direction of the magnetic disk 16. On the magnetic disk 16 shown in FIG. 3, the X zone 161x is assigned to the system area, and the Y zone 161y is assigned to the parameter area. Further, on the magnetic disk 16, other A zone 161a and B zone 161b except for the X zone 161x and the Y zone 161y, are the user areas. Hereinafter, the X zone 161x is also referred to as the system area 161x, and the Y zone 161y is also referred to as the parameter area 161y.

Herein, the user area corresponds to an example of the first storing area in the basic structure, and the parameter area corresponds to an example of the second storing area in the basic structure. Further, the data stored in the user area corresponds to an example of the first-type data in the basic structure, and the parameter stored in the parameter area corresponds to an example of the second-type data in the basic structure.

Since a recording frequency is constant within one zone of the magnetic disk 16, the length of the recording area per bit becomes gradually longer from the inner circumference to the outer circumference, the zone on the outer circumference has a higher recording frequency so as to set the length of the one-bit area over all zones within a predetermined range (zone CAV system). The information on the tracks is recorded with division on the unit basis of sector. In the zone CAV system, the number of sectors arranged per track is varied depending on zones, and a relationship between the positions of the servo areas SV1, SV2, . . . appearing on the tracks and the position of the sectors depending on the zone.

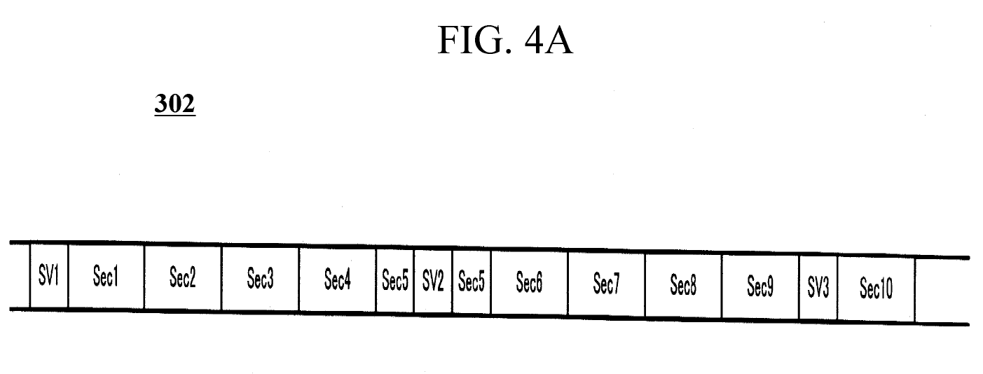

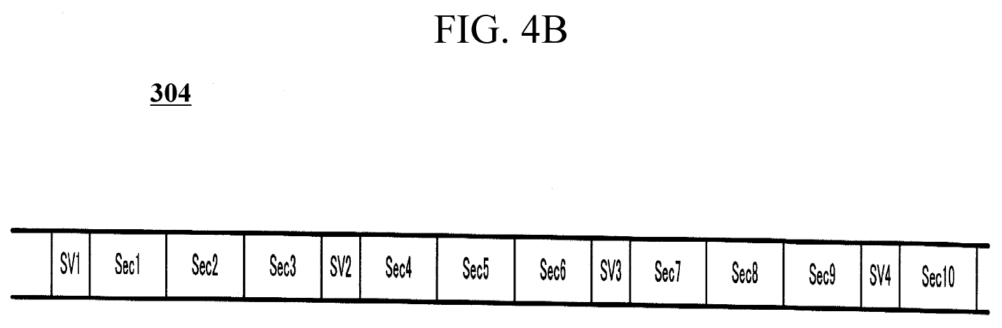

FIGS. 4A and 4B are diagrams for explaining an example of arrangement of the sectors on the tracks on the magnetic disk shown in FIG. 3.

FIG. 4A shows a part of sectors 302 in one track within the A zone 161a on the magnetic disk 16 shown in FIG. 3, and FIG. 4B shows a part of sectors 304 in one track within the B zone 161b.

The number of servo areas per track is the same in all zones. However, the number of sectors per track is varied depending on the zones in accordance with the recording frequency. For example, as shown in FIG. 4A, first sector Sec1 to third sector Sec3 and the former half of a fourth sector Sec4 are arranged between the first servo area SV1 and the next second servo area SV2 on the tracks on the A zone 161a (refer to FIG. 3). The other half of the fourth sector Sec4 is arranged subsequently to the second servo area SV2. Next, fifth sector Sec5 to ninth sector Sec9 are arranged just before the third servo area SV3. As shown in FIG. 4B, the first sector Sec1 to third sector Sec3 are arranged between the first servo area SV1 and the next second servo area SV2 on the tracks in the B zone 161b (refer to FIG. 3). Subsequently, the fourth sector Sec4 to sixth sector Sec6 are arranged between the second servo area SV2 and the third servo area SV3. As mentioned above, relationships between the positions of the servo areas SV1, SV2, . . . appearing on the tracks and the positions of the boundaries of the sectors Sec1, Sec2, . . . are varied depending on the zones. The HDD 100 has a sector pulse (SCTP) positional-information table indicating the relationships between the positions of the servo areas SV1, SV2, . . . appearing on the tracks and the positions of the boundaries of the sectors Sec1, Sec2, . . . depending on the zones. The HDD 100 extracts the data in a target sector from the signal read from the magnetic head 15 by using the table, or supplies the signal of the data to the magnetic head 15 at the timing corresponding to the target sector.

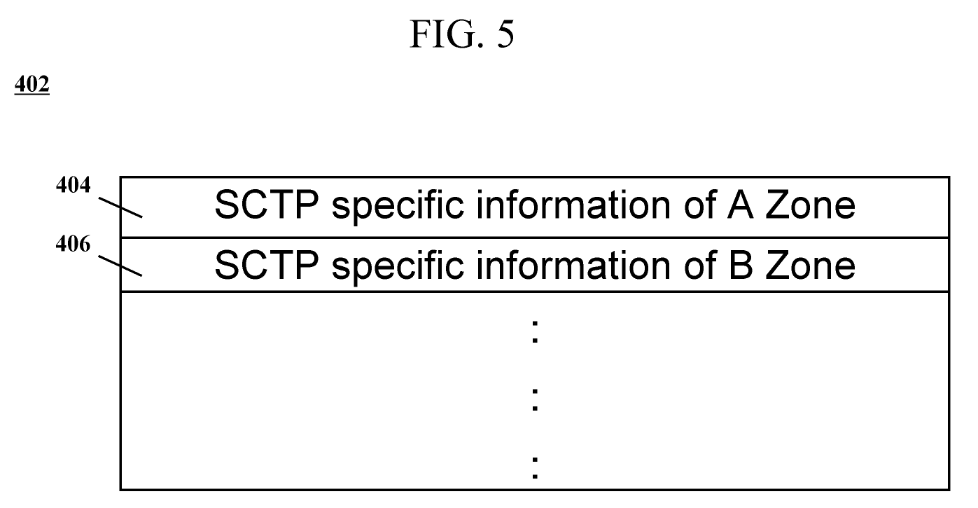

FIG. 5 is a diagram showing the sector pulse positional-information table 402.

The sector pulse positional-information table shown in FIG. 5 is stored to the parameter area 161y, and specific information of the sector pulse 404 is stored for the A zone and specific information of the sector pulse 406 is stored for B zone. The specific information of the sector pulse indicates how apart the head of the sector on the tracks is positioned in which of the servo areas. The sector pulse positional-information table stored in the parameter area 161y is read after turning on the HDD 100, and is stored to the work memory 10. Upon writing and reading the data and the parameter, when seeking the magnetic head 15, the MPU 9 supplies the specific information of the sector pulse corresponding to the zone as the target track of the sector pulse positional-information table stored in the work memory 10, to the formatting control unit 6.

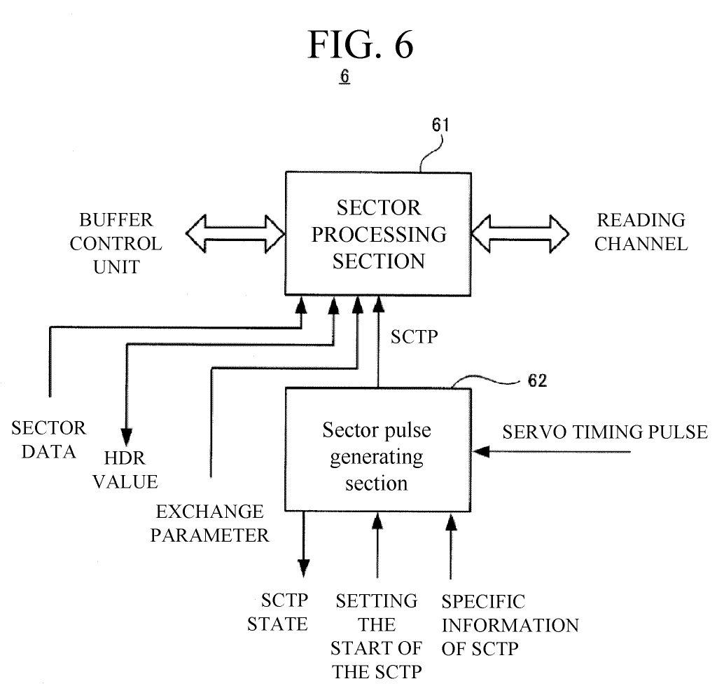

FIG. 6 is a block diagram showing the structure of the formatting control unit shown in FIG. 2.

The formatting control unit 6 comprises: a sector pulse generating section 62 that generates a sector pulse indicating the timing of the sector; and a sector processing section 61 that performs processing of the sector in accordance with the sector pulse generated by the sector pulse generating section 62. The sector pulse generating section 62 in the formatting control unit 6 creates a sector pulse (SCTP) as a timing signal for specifying a target sector in accordance with a servo timing pulse indicating the timing for reading the servo area and specific information of the sector pulse, as information written by the MPU 9. The servo timing pulse is supplied from the reading channel 7. The sector pulse generating section 62 has a function for setting whether or not a pulse is generated (for setting the start of the SCTP) by the MPU 9 and a function for reading a state (SCTP state) indicating that the pulse is generated by the MPU 9.

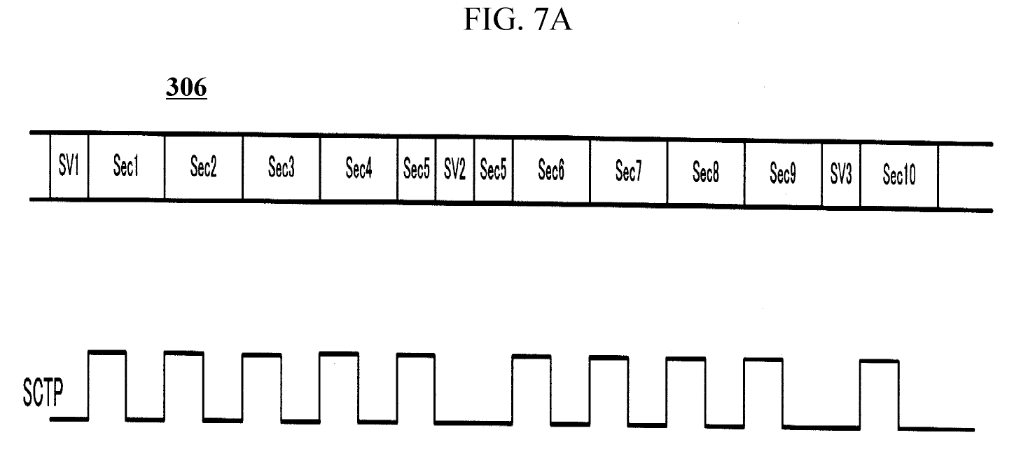

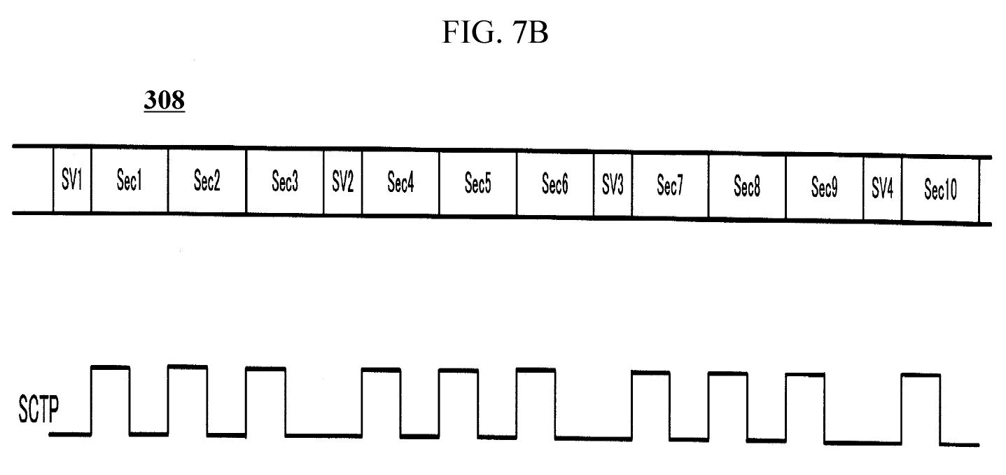

FIGS. 7A and 7B are timing charts for explaining a relationship between the data read from the magnetic disk and the sector pulse.

FIG. 7A shows a timing chart 306 indicating the timing of the data read out from one track within the A zone 161a on the magnetic disk shown in FIG. 3. FIG. 7B shows a timing chart 308 indicating the timing of the data read out from one track within the B zone 161b.

Upon setting the specific information of the sector pulse corresponding to the A zone 161a in the SCTP positional-information table, the sector pulse generating section 62 in the formatting control unit 6 creates the SCTP synchronized with the timing of the sector on the basis of the positions of the servo areas of the data read from the track of the A zone 161a, as shown in FIG. 7A. Further, upon setting the sector-pulse specific information corresponding to the B zone 161b in the SCTP positional-information table, as shown in FIG. 7B, the sector pulse generating section 62 creates the SCTP synchronously with the timing of the sector within the data read from the tracks of the B zone 161b. Upon writing the data, similarly to the reading time, the data in the servo areas is read and the SCTP is generated.

Upon reading the data, the sector processing section 61 shown in FIG. 6 extracts the data of the sector from among the data transmitted from the reading channel 7 at the timing of the sector pulse. Upon writing the data, the sector processing section 61 shown in FIG. 6 supplies the data of the sector to the reading channel 7 at the timing of the sector pulse. The sector pulse generating section 62 and sector processing section 61 obtain the data of the target sector from the data on the track read from the magnetic head 15 or writes the data to the target sector on the magnetic disk 16. The sector processing section 61 converts the data on the basis of the converting parameter set by the MPU 9, and adds or reads the header of the sector under the control of the MPU 9. Further, the sector processing section 61 has a function for setting a value set by the MPU 9 as the sector data so as to format the magnetic disk 16 and for outputting the set value to the reading channel 7.

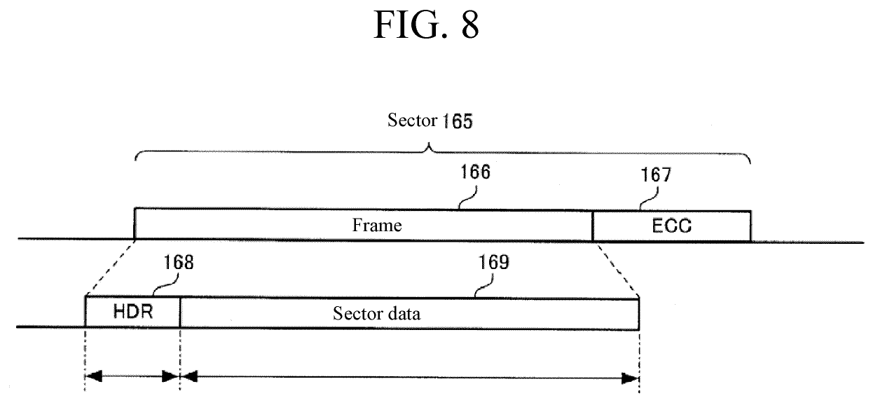

FIG. 8 is a diagram showing the data structure of the sector stored in the magnetic disk shown in FIG. 3.

As described above with reference to FIGS. 4A and 4B, the magnetic disk 16 stores the data on the unit basis of sector. The sector 165 includes a frame 166 and ECC (Error Correcting Code) 167. The ECC 167 is code for detecting an error of the data and correcting the error. Data in the frame 166 further includes a header (HDR) 168 and sector data 169. The HDR 168 corresponds to an example of the sector information as the above-mentioned applying structure. The HDR 168 expresses the attribute of the sector 165 and also information suggesting a state as whether or not the parameter stored in the magnetic disk 16 is to be protected according to the embodiment. An initial value A of the HDR 168 indicates a state in which the parameter stored in the parameter area is not to be protected, i.e., a free state of writing and reading the data in response to the vendor command. Further, another value B changed from the initial value A indicates a state in which the parameter is to be protected.

Upon writing the data, the sector processing section 61 in the formatting control unit 6 adds the HDR 168 and the ECC 167 of the value set by the MPU 9 to the data received from the host IF control unit 2, thereby forming the sector 165 and outputting the formed sector to the reading channel 7. Upon reading the data, the sector processing section 61 extracts the sector 165 from among the data transmitted from the reading channel 7, detects and corrects an error, excludes the ECC 167 and the HDR 168, thus sets the sector data, and outputs the sector data to the buffer control unit 3. The HDR 168 is read by the MPU 9.

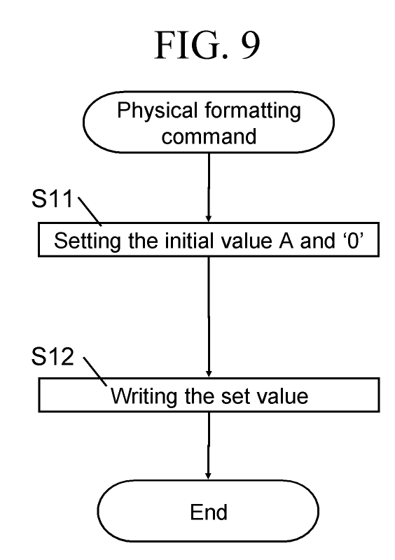

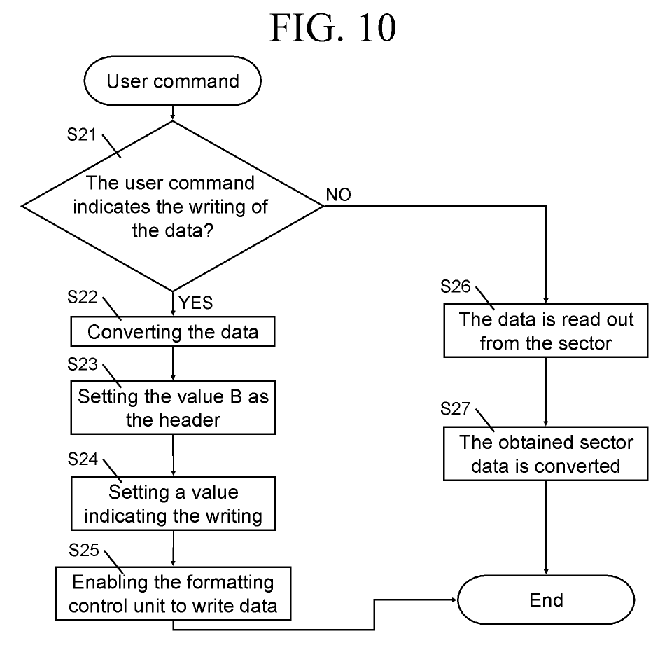

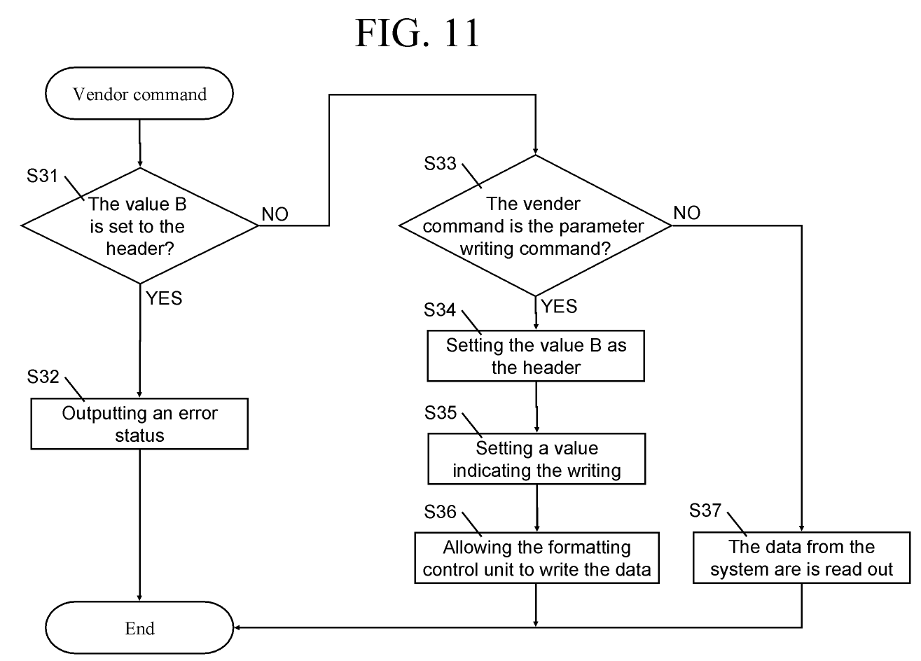

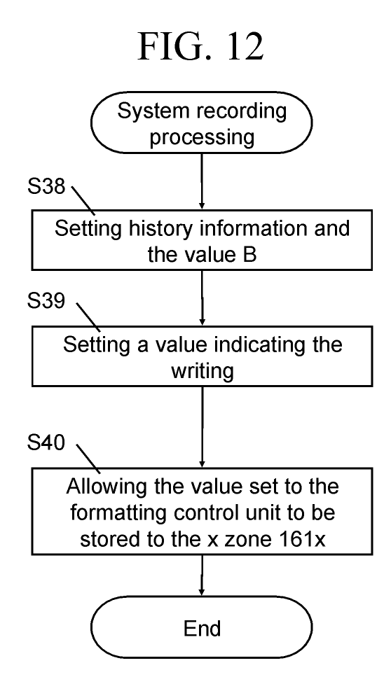

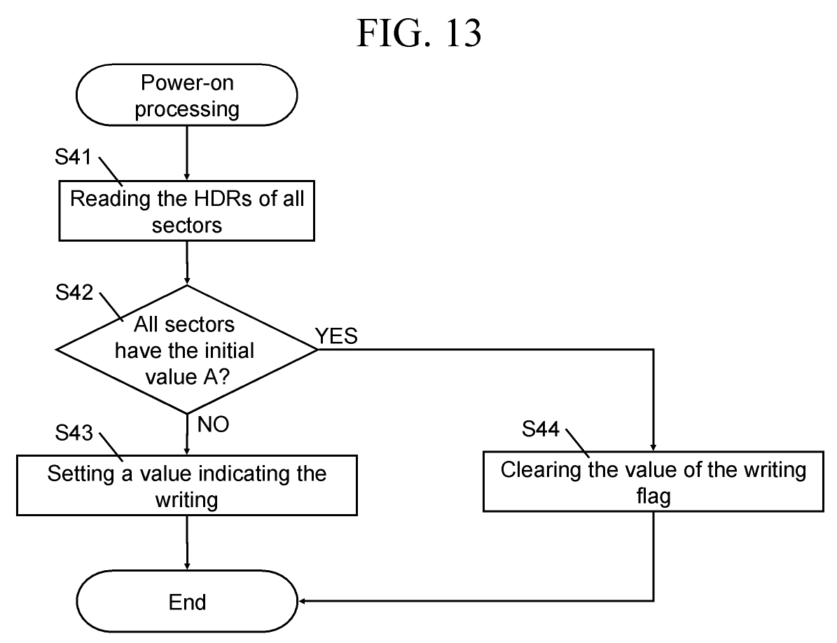

FIGS. 9 to 13 are flowcharts for explaining processing of the HDD shown in FIG. 2. FIG. 9 shows physical formatting processing of the magnetic disk. FIG. 10 shows user command (Cmd) processing. FIG. 11 shows vendor command (Cmd) processing. FIG. 12 shows system recording processing. The HDD 100 receives the command transmitted from the external computer C (refer to FIG. 1) or the setting device A to the host IF control unit 2, and executes the processing shown in FIGS. 9 to 11 in response to the received command. The command externally-received by the HDD 100 includes a user command for storing or reading the data to the HDD 100 by the external computer C and a vendor command for storing and reading the parameter to the HDD 100 by the setting device A. Further, upon turning on the HDD 100, the system recording processing shown in FIG. 12 and power-on processing shown in FIG. 13 are continuously executed.

After the setting device A writes the parameter to the parameter area on the magnetic disk 16 in the manufacturing step of the HDD 100, the physical formatting processing shown in FIG. 9 is executed by receiving the physical formatting command. Although the physical formatting command is one of the vendor commands, the data is not received and transmitted. Therefore, the physical formatting command will be described, separately from the vendor command, which will be described later.

In the physical formatting processing, the MPU 9 of the HDD 100 sets the initial value A as a value of the header (HDR) 168 (refer to FIG. 8) to the formatting control unit 6, and also sets ‘0’ as the sector data 169 (in step S11). Herein, the initial value A suggests a state in which the parameter stored in the parameter area is not to be protected.

Subsequently, the MPU 9 allows the servo control unit 12 to drive the VCM 12 and the SPM 14, thereby writing the set value to the formatting control unit 6 (in step S12). The formatting control unit 6 sets, as the sector 165, the data added with the ECC 167 to the frame 166 including sector data 169 to which ‘0’ is entirely set and the HDR 168 to which the initial value A is set, and writes the set data to the A zone 161a to the X zone 161x on the magnetic disk 16. As a consequence thereof, the physical formatting of the magnetic disk 16 is executed. In a state in which the physical formatting processing ends, all the HDRs 168 included in the sector arranged to the A zone 161a to X zone 161x on the magnetic disk 16 are the initial value A. Incidentally, since the Y zone 161y that stores the parameter is not physically formatted, the parameter is not erased. In the state, the manufacturing of the HDD 100 ends and the HDD 100 is shipped to the factory. The HDD 100 in the state is connected to the computer C, and the data can be then stored and read in response to the user command from the computer C.

The user command processing shown in FIG. 10 is executed by receiving the user command from the computer C by the HDD 100. The user command includes a data writing command and a data reading command. In the case of the data writing command, the computer C transmits the data in response to the command. The data is temporarily stored to the buffer memory 4 or buffer non-volatile memory 5 by the buffer control unit 3, and is thereafter transmitted to the formatting control unit 6.

The MPU 9 in the HDD 100 determines whether or not the user command transmitted to the host ID control unit 2 indicates the writing of the data (in step S21). When the user command indicates the writing of the data (YES in S21), the MPU 9 reads the converting parameter stored in the system area on the magnetic disk 16 and sets the read parameter to the formatting control unit 6, and converts the data transmitted from the buffer control unit 3 on the basis of the converting parameter (in step S22).

Subsequently, the MPU 9 sets the value B as the header (HDR) 168 (refer to FIG. 8) to the formatting control unit 6 (in step S23), and sets a value indicating the writing to the writing flag 10a arranged to the work memory 10 (in step S24). The value B of the HDR suggests a state in which the parameter stored in the parameter area is to be protected, more specifically, a state in which the writing and reading of the parameter in response to the vendor command are prohibited.

Thereafter, the MPU 9 enables the formatting control unit 6 to write the data (in step S25). In step S25, the formatting control unit 6 adds the HDR and ECC to which the value B is set, forms the sector 165 (FIG. 8) to the data that is received by the buffer control unit 3 and is converted by the converting parameter, and outputs the formed sector to the reading channel 7. The reading channel 7 modulates/demodulates the code of the received sector, and transmits the obtained signal to the magnetic head 15 via the head IC 8. As a consequence thereof, the sector is written to the user area on the magnetic disk 16. As a consequence thereof, the HDR of the sector is rewritten from the initial value A to the value B.

When it is determined in step S21 that the user command is the data reading command (NO in step S21), the data is read from the sector arranged to the user area (in step S26). More specifically, the signal read from the magnetic head 15 is transmitted to the formatting control unit 6 via the head IC 8 and reading channel 7. The formatting control unit 6 extracts the sector in accordance with the sector pulse, performs error correction using the ECC, and obtains the sector data by excluding the ECC and HDR. The obtained sector data is converted by the converting parameter (in step S27). As a consequence thereof, data having the same contents as those transmitted from the computer C at the data writing time is obtained. The obtained sector data is outputted to the computer C via the buffer control unit 3 and the host IF control unit 2. The writing and reading in steps S12, S25, and S26 include the setting processing of the SCTP table and the seeking processing for moving the magnetic head to the track to which the target sector is arranged. The processing will be described later according to the following embodiment.

With the user command processing, the writing and reading of the data using the user command are realized to the user area on the magnetic disk 16. The sector to which the data is written has the HDR having the value B. Further, upon writing the data once, the writing flag 10a set to the work memory 10 is set to a value indicating the writing, and indicates on which sector on the magnetic disk 16, and the data is written.

The vendor command processing shown in FIG. 11 is executed by receiving the vendor command from the setting device A by the HDD 100. The vendor command includes a parameter writing command for storing (writing) the parameter and a parameter reading command for reading the parameter. In the case of the parameter writing command, the parameter is also transmitted in response to the command. The parameter is stored to the buffer memory 4 or buffer non-volatile memory 5 by the buffer control unit 3, and is transmitted to the formatting control unit 6.

In the vendor command processing, the MPU 9 of the HDD 100 first determines whether or not the value B is set to the HDR included in the sector on the magnetic disk 16 (in step S31). In the processing in step S31, the MPU 9 reads all sectors arranged to the A zone 161a to X zone 161x on the magnetic disk 16, and determines whether or not the value B is set to the HDR in any of the read sectors. However, according to the embodiment, in place of reading the sector from the magnetic disk 16, it is determined whether or not a value indicating the writing is set to the writing flag 10a arranged to the work memory 10.

In the determining processing in step S31, the value B is set to the HDR (YES in step S31), the MPU 9 assumes that the data is written at least once after the physical formatting (FIG. 9), and prevents the access using the vendor command to the magnetic disk 16. More specifically, the MPU 9 enables the host IF control unit 2 to output an error status in response to the vendor command (in step S32). As a consequence thereof, when the data is written into the user area at least once after the physical formatting, the parameter stored in the system area is prohibited from being written over. Therefore, after the shipping to the factory, it is possible to prevent the situation in which the parameter stored in the system area on the magnetic disk 16 is carelessly rewritten.

On the other hand, when the value B is not set to the HDR in all the sectors arranged from the A zone 161a to X zone 161x (NO in step S31), the MPU 9 determines whether or not the vendor command is the parameter writing command (in step S33). When the vendor command is the parameter writing command (YES in step S33), the MPU 9 sets the value B as the header (HDR) 168 (refer to FIG. 8) to the formatting control unit 6 (in step S34) and sets a value indicating the writing to the writing flag 10a arranged to the work memory 10 (in step S35). The MPU 9 allows the formatting control unit 6 to write the data (in step S36). On the other hand, when the vendor command is the parameter reading command (NO in step S33), the data from the system area is read (in step S37).

Herein, of the user command processing shown in FIG. 10 and the vendor command processing shown in FIG. 11, the combination of the MPU 9 that executes the processing in steps S33 to S37 and the IF control unit 2, buffer control unit 3, formatting control unit 6, reading channel 7, head IC 8, and magnetic head 15 shown in FIG. 2 corresponds to an example of the access unit in the basic structure. Further, of the vendor command processing shown in FIG. 11, the MPU 9 that executes the processing in steps S31 and S32 corresponds to an example of the preventing unit in the basic structure.

The system recording processing shown in FIG. 12 is executed in the case of turning on the HDD 100 and in an idling state in which the HDD 100 does not receive the command for a predetermined period.

In the system recording processing, the MPU 9 first sets, to the formatting control unit 6, history information on the number of access times as the sector data 169, and the value B as the header (HDR) 168 (refer to FIG. 8) (in step S23). Further, the MPU 9 sets a value indicating the writing to the writing flag 10a arranged to the work memory 10 (in step S24). Thereafter, the MPU 9 allows the value set to the formatting control unit 6 to be stored to the X zone 161x as the system area on the magnetic disk 16 (in step S40).

With the system recording processing shown in FIG. 12, upon turning on the HDD 100, the HDR of the sector in the system area is set as the value B and the writing flag 10a is set. Therefore, upon executing the vendor command processing shown in FIG. 11 in response to the vendor command after turning on the HDD 100, the writing and reading of the parameter are prohibited.

The power-on processing shown in FIG. 13 is executed by turning on the HDD 100 subsequently to the system recording processing shown in FIG. 12.

The MPU 9 reads the HDRs of all sectors from the magnetic disk 16 (in step S41), and determines whether or not the HDRs of all sectors have the initial value A (in step S42). The HDR is read from the formatting control unit 6. When there is at least one sector whose HDR does not have the initial value A (NO in step S42), the MPU 9 sets a value indicating the writing to the writing flag 10a arranged to the work memory 10 (in step S43). On the other hand, when the HDRs of the sectors have the initial value A (YES in step S42), the MPU 9 clears the value of the writing flag 10a arranged to the work memory 10 (in step S44).

The contents of the writing flag 10a of the work memory 10 are lost by turning off the HDD 100. However, the power-on processing always reflects the HDR state of the sector on the magnetic disk 16. Therefore, both upon turning off the power and upon turning on the power, it can be simply determined, by checking the value of the writing flag 10a, whether or not the HDR of the sector has the initial value A in the vendor command processing shown in FIG. 11, irrespective of a large number of the sectors.

The first embodiment is described above. Herein, as the applying structure of the basic structure, preferably, a recording medium stores the first-type data and the second-type data on the unit basis of sector, and further stores start positional information indicating the start position of the sector on the recording medium. The recording medium comprises: a timing signal generating unit that obtains the start positional information from the recording medium and generates a timing signal indicating an access timing to the sector on the basis of the start positional information.

The access unit accesses the sector at the timing of the timing signal generated by the timing signal generating unit.

When the suggestion information suggests the state in which the second-type data is to be protected, the preventing unit prevents the timing signal generating unit from generating the timing signal at the timing when the access unit receives the second-system command.

With the applying structure, when the second-type data is to be protected, the sector cannot be obtained, thereby protecting the second-type data without fail.

Next, a description will be given of an HDD as an information storing device in the basic structure and applying structure thereof according to the second embodiment. An HDD 200 according to the second embodiment has the same hardware structure as that shown in FIG. 2 according to the first embodiment, and the hardware structure of the HDD 200 will be described with that shown in FIG. 2. The same components as those according to the first embodiment are designated by the same reference numerals, and different points from those according to the first embodiment will be described.

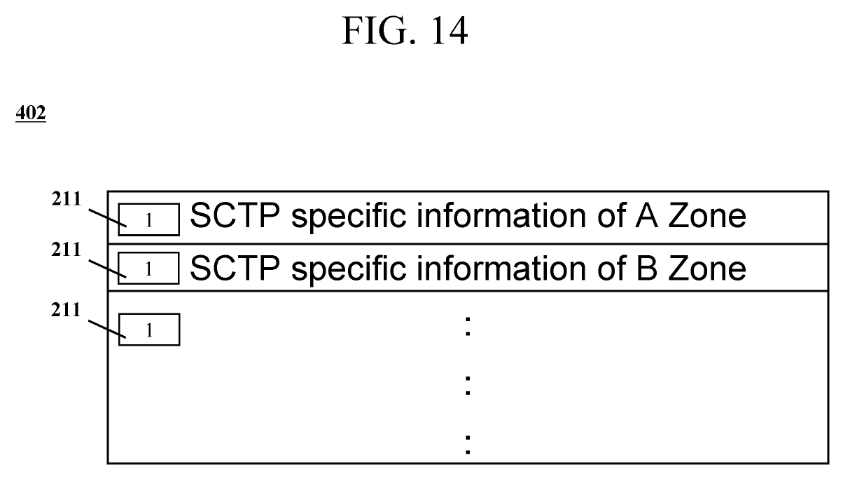

FIG. 14 is a diagram showing a sector pulse (SCTP) positional-information table 402 of the HDD according to the second embodiment.

Unlike the SCTP positional-information table according to the first embodiment, the SCTP positional-information table shown in FIG. 14 has a first flag 211 indicating whether or not the physical formatting of the magnetic disk 16 ends. The first flag 211 shown in FIG. 14 is provided every zone, and the same value is set to the first flag 211 for each zone. A value ‘1’ indicates the end of the physical formatting, and suggests a state in which the parameter is to be protected.

Herein, the SCTP positional-information table corresponds to an example of the start positional information in the applying structure, and the first flag 211 corresponds to an example of the suggestion information in the applying structure. Further, the sector pulse generating unit shown in FIG. 6 corresponds to an example of the timing signal generating unit in the applying structure.

Further, the HDD 200 according to the second embodiment has a second flag 212 indicating that the vendor command is received after the physical formatting ends in the program memory 11.

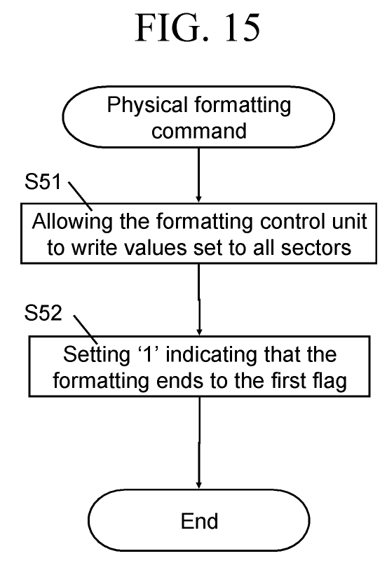

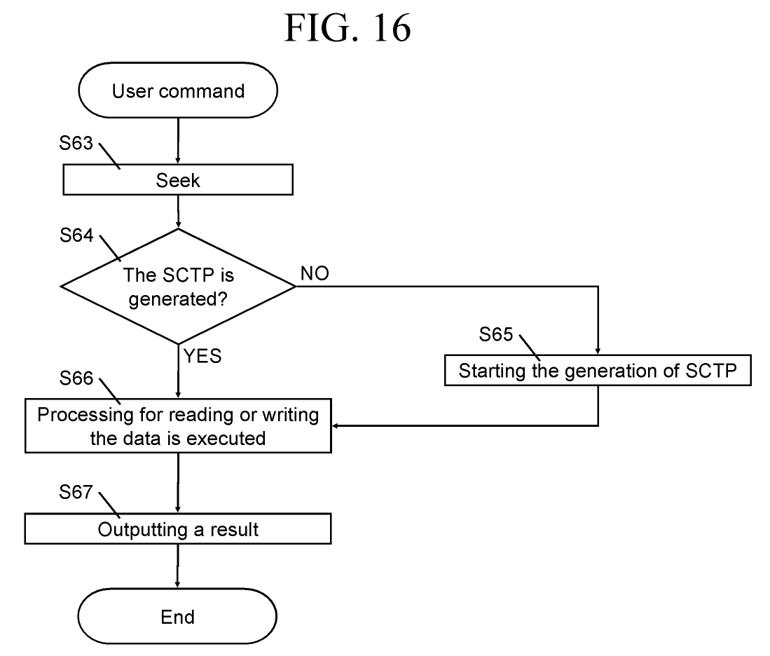

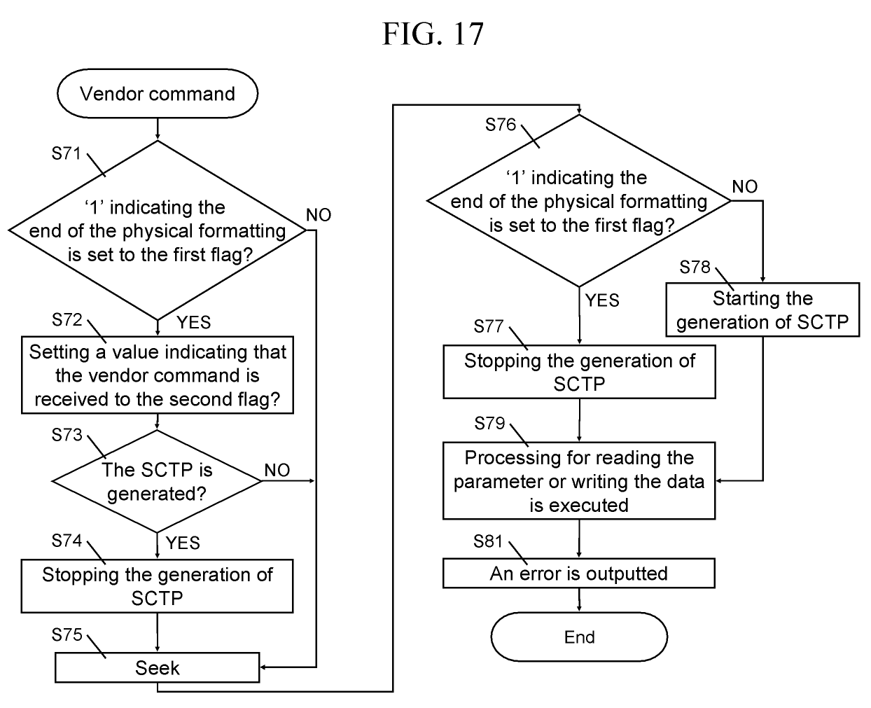

FIGS. 15 to 17 are flowcharts for explaining processing of the HDD 200 according to the second embodiment. FIG. 15 shows physical formatting processing of the magnetic disk, FIG. 16 shows user command (Cmd) processing, and FIG. 17 shows vendor command (Cmd) processing.

The physical formatting processing shown in FIG. 15 is executed by receiving the physical formatting command from the setting device A by the HDD 200. The MPU 9 allows the servo control unit 12 to drive the VCM 12 and the SPM 14, and further allows the formatting control unit 6 to write values set to all sectors (in step S51). The formatting control unit 6 sets the data added with the ECC 167 as the sector 165 to a frame 166 including sector data 169 (refer to FIG. 18) to which ‘0’ is entirely set and the HDR 168 to which the initial value A is set, and writes the data to all areas on the magnetic disk 16. As a consequence thereof, the physical formatting of the magnetic disk 16 is executed.

Thereafter, the MPU 9 sets ‘1’ indicating that the formatting ends to the first flag 211 indicating whether or not the formatting ends in the SCTP positional-information table recorded to the system area on the magnetic disk 16.

Herein, the physical formatting command corresponds to an example of “the command for instructing the rewriting of the suggestion information” in the applying structure.

The user command processing shown in FIG. 16 is executed by receiving the user command from the computer C by the HDD 200.

In the user command processing, the MPU 9 executes seeking processing (in step S63). According to the second embodiment, the seeking processing has a feature. Therefore, the seeking processing that is not specifically described according to the first embodiment is described here. A sector number of the sector as a writing or reading target is added to the user command. The MPU 9 obtains the track number of the tracks corresponding to the sector number. When the track of the obtained number is different from the track where the magnetic head 15 is currently positioned, the MPU 9 allows the servo control unit 12 to drive the VCM 13 so as to move the magnetic head 15. Further, when the target track belongs to the zone different from that of the current track, the SCTP table corresponding to the zone of the target track is set to the formatting control unit 6. Incidentally, the SCTP table shown in FIG. 14 is read from the parameter area 161y on the magnetic disk 16 at the power-on time, and is stored to the work memory 10. Further, when the track of the target sector is the same as the current track in step S63, the magnetic head 15 is not moved.

The MPU 9 reads the SCTP state from the sector pulse generating section 62 in the formatting control unit 6, thereby checking whether or not the SCTP is generated (in step S64). When the SCTP is not generated, the start of SCTP is set to the sector pulse generating section 62, thereby starting the generation of SCTP (in step S65).

Subsequently, processing for reading or writing the data is executed (in step S66). A specific description will be given of the reading processing. Upon executing the reading processing, the magnetic head 15 is positioned to the track in response to the user command, and the data stored to the track of the sector number is read. The data on the read track is supplied to the sector processing section 61 in the formatting control unit 6 via the head IC 8 and the reading channel 7. The sector pulse shown in FIGS. 7A and 7B are supplied to the sector processing section 61 from the sector pulse generating section 62 in the formatting control unit 6 in accordance with the servo timing pulse and the set SCTP table. The sector processing section 61 extracts the target sector from the data of the track at the timing of the sector pulse, excludes the ECC and the HDR, and obtains the sector data. The sector data obtained by the formatting control unit 6 is outputted to the external computer C via the buffer control unit 3 and the host IF control unit 2.

The MPU 9 allows the host IF control unit 2 to output the status information indicating the executing result. Generally, information indicating the end of command as the executing result is outputted to the computer C.

The vendor command processing shown in FIG. 17 is executed by receiving the vendor command from the computer C by the HDD 200.

In the vendor command processing, the MPU 9 determines whether or not ‘1’ indicating the end of the physical formatting is set to the first flag 211 in the SCTP positional-information table (in step S71).

When ‘1’ is set in step S71 (YES in step S71), the physical formatting ends. In the case, after ending the physical formatting, the MPU 9 sets a value indicating that the vendor command is received to the second flag 212 (in step S72). Further, the MPU 9 checks, by reading the SCTP state from the sector pulse generating section 62 in the formatting control unit 6, whether or not the SCTP is generated (in step S73). When the SCTP is generated (YES in step S73), the MPU 9 allows the sector pulse generating section 62 to stop the generation of the SCTP (in step S74). As a consequence thereof, at the timing of receiving the vendor command, the generation of the SCTP is prohibited.

When ‘1’ is not set in the determining processing in step S71 (NO in step S71), the processing in steps S71 to S74 is not executed.

Subsequently, the MPU 9 executes seeking processing (in step S75). The description of the processing in step S75 is omitted because of overlapping to that of step S63.

After the seeking processing, the MPU 9 determines whether or not ‘1’ indicating the end of the physical formatting is set to the first flag 211 in the SCTP positional-information table (in step S76).

When ‘1’ is set to the first flag 211 (YES in step S76), the MPU 9 allows the sector pulse generating section 62 to stop the generation of the SCTP (in step S74). As a consequence thereof, even if setting the generation of the SCTP in the seeking processing, the generation of the SCTP can be prevented. When ‘1’ is not set to the first flag 211 (NO in step S76), the MPU 9 allows the sector pulse generating section 62 to generate the SCTP (in step S78).

Subsequently, processing for reading the parameter or writing the data is executed (in step S79). Herein, when the sector pulse generating section 62 does not generate the SCTP, the sector processing section 61 does not detect the start position of a proper sector. As a consequence, an error is outputted as a result of executing the command (in step S81). Further, even if outputting any value of the sector data, the value is irrespective of the parameter stored in the magnetic disk 16.

Herein, the SCPT stop processing in step S74 and the SCTP preventing processing in step S77 correspond to an example of the preventing unit in the basic structure.

With the vendor command processing shown in FIG. 17, when ‘1’ indicating the end of the physical formatting is set to the first flag 211 in the SCTP positional-information table, the SCTP is not generated and the data of the sector is not obtained. As a consequence thereof, the parameter is protected from the careless reading and writing. On the other hand, in the user command processing shown in FIG. 16, the reading and writing of user data are not limited.

Incidentally, in the description of the embodiments, as an example of the recording medium in the basic structure mentioned above in “Summary”, the magnetic disk is shown. Alternatively, the recording medium may be an optical-magnetic disk or an optical disk in addition to the magnetic disk.

Further, in the description of the embodiments, the HDR is shown as an example of the sector information in the applying structure mentioned above in “Summary”. Alternatively, the sector information may indicate the attribute of the sector, such as the sector number, in addition to indicate the suggestion information.

Further, in the description of the embodiments, the parameter for converting the data written and read is shown as an example of “the second-type data used for writing and reading the first-type data” in the basic structure mentioned above in “Summary”. Alternatively, the second-type data may be the parameter for setting response adjustment of the servo, in addition to the converting parameter.

Further, in the description of the embodiments, the physical formatting command is shown as an example of the “command for instructing the rewriting of the suggestion information” in the applying structure mentioned above in “Summary”. Alternatively, “the command for instructing the rewriting of the suggestion information” may be a command provided independently of the physical formatting command, e.g., an independent command for prohibiting the writing.

Further, in the description of the embodiments, as examples of the basic structure mentioned above in “Summary”, the first embodiment in which an error is outputted to the vendor command in accordance with the value of the HDR and the second embodiment in which the generation of the SCTP is prevented in accordance with the first flag 211 in the SCTP positional-information table are shown. Alternatively, the basic structure may be a combination of the components according to the first and second embodiment, e.g., a structure in which the generation of the SCTP is prevented in accordance with the value of the HDR or a structure in which an error is outputted to the vendor command in accordance with the first flag in the SCTP positional-information table.

Hereinbelow, the following appendixes will be further disclosed with respect to various ones of the basic structure and the applying structure thereof.

With the basic structure of the information storing device, when the suggestion information suggests the state in which the second-type data is to be protected, it is prevented that the access unit accesses the recording medium in response to the second-system command. Therefore, the operation for writing or outputting the second-type data is prevented. On the other hand, the operation for writing or outputting the first-type data in accordance with the first-system command is not prevented. Therefore, the operation for writing or outputting the second-type data can be protected while an external computer writes and outputs the first-type data.

Herein, as one applying structure of the basic structure, preferably, in an initial state in which the first storing area and/or the second storing area stores the first-type data and/or the second-type data and the suggestion information, suggestion information suggesting a state in which the second-type data is not to be protected is stored.

Further, when the access unit receives the first-system command and/or the second-system command and writes the first-type data and/or the second-type data to the first storing area and/or the second storing area, the suggestion information is rewritten to information suggesting a state in which the second-type data is to be protected.

With the applying structure, before shipping the information storing device as a product, the suggestion information is set to the initial state. Then, when the data is thereafter stored in the recording medium, it is recognized that the data is stored after the product shipment and the suggestion information is rewritten. Further, it is prevented that the access unit accesses the recording medium in accordance with the second-system command. Therefore, the protection of the second-type data is easily performed after the product shipment.

Furthermore, as another applying structure of the basic one, preferably, the recording medium stores the first-type data and/or the first-type data to the first storing area and/or the second storing area on the unit basis of sector. The sectors also store sector information also serving as the suggestion information.

When the access unit receives the first-system command and/or the second-system command and writes the first-type data and/or the second-type data to the first storing area and/or the second storing area, the sector information on the sector to which the first-type data and/or second-type data is written is rewritten to sector information suggesting a state in which the second-type data to be protected. When the sector information suggests a state in which the second-type data is to be protected in any of sectors, the preventing unit prevents the access unit from accessing the recording medium in accordance with the second-system command.

With the other applying structure, in the case of writing the data, the suggestion information is stored to the sector in the recording medium, and the operation for writing the suggestion information can be therefore performed simultaneously with the operation for writing the data.

With the other applying structure, preferably, the information storing device further has a power-on access unit that, at the timing for turning on the information storing device, writes the first-type data and/or the second-type data to the first storing area and/or the second storing area, and rewrites the sector information on the sector to which the first-type data and/or second-type data is rewritten to sector information suggesting a state in which the second-type data is to be protected.

With the other applying structure, preferably, not only the command is received but also the sector information is rewritten by tuning on the device and the second-type data in the recording medium having the suggestion information in the initial state is therefore protected just after the power-on of the information storing device.

Further, with the other applying structure of the basic one, preferably, the preventing unit prevents the access unit from receiving the second-system command.

With the other applying structure, the result can be notified to an external device for a short time without access time to the recording medium.

Furthermore, with the basic structure, the second command system may include a command for instructing the rewriting of the suggestion information.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A method of controlling a memory device connectable to an information apparatus for sending out a command to the memory device, the memory device having a medium for storing data and a head for writing data into and reading data from the medium, the method comprising:
storing parameter information for writing data into and reading out the data from the medium, into the medium when formatting the medium;
writing into the medium history information indicating user data has been written into the medium in accordance with the parameter information; and
determining whether to allow the parameter information to be changed when a command for writing new parameter information is received from the information apparatus in accordance with the history information.

2. The method of claim 1, wherein the history information indicates the parameter information is not to be protected in an initial state.

3. The method of claim 2, further comprising rewriting the history information indicating the parameter information is to be protected when user data is written into the medium.

4. The method of claim 3, further comprising prohibiting the parameter information to be changed when the history information indicates the parameter information is to be protected.

5. The method of claim 1, wherein the writing writes the history information indicating user data has been written into upon detecting a power-on of the memory device.

6. A memory device connectable to an information apparatus for sending out a command to the memory device, the memory device including a head for writing and reading data, comprising:
a medium that stores parameter information for writing data into and reading out the data from the medium, into the medium when formatting the medium; and
a controller that makes the head to write into the medium history information indicating user data has been written into the medium in accordance with the parameter information, and determines whether to allow the parameter information to be changed when a command for writing new parameter information is received from the information apparatus in accordance with the history information.

7. The memory device of claim 6, wherein the history information indicates the parameter information is not to be protected in an initial state.

8. The memory device of claim 7, wherein the controller rewrites the history information indicating the parameter information is to be protected when user data is written into the medium.

9. The memory device of claim 8, wherein the controller prohibits the parameter information to be changed when the history information indicates the parameter information is to be protected

10. The memory device of claim 6, wherein the controller writes the history information indicating user data has been written into upon detecting a power-on of the memory device.
